(19) United States
(12) Patent Application Publication
(10) Pub. No.: US 2024/0371295 A1
(43) Pub. Date: Nov. 7, 2024

(54) TUTORIAL CHESS GAME FOR BEGINNERS

(71) Applicants: DIEGO FRANCISCO MILLA PEREZ, Miami, FL (US); FEDERICO DIAZ, Norwich (GB)

(72) Inventors: DIEGO FRANCISCO MILLA PEREZ, Miami, FL (US); FEDERICO DIAZ, Norwich (GB)

(21) Appl. No.: 18/143,579

(22) Filed: May 4, 2023

(51) Int. Cl. G09B 19/22; A63F 3/00

(52) U.S. Cl. CPC G09B 19/22; A63F 3/00634; A63F 3/02

(57) ABSTRACT

The general tenor of the invention concerns any board game having game pieces and movements dictated by the game's rules, e.g., chess. An embodiment of the present invention contemplates a game board apparatus for playing a game, which may include: at least one game piece that includes a unique protrusion extending from its base, at least two sub-boards that are releasably interconnected using a plurality of connection tabs and a plurality of corresponding connection receptacles; a plurality of channels of each sub-board that are alignable with each other, wherein at least one of the plurality of channels may be modelled after permitted movements for the at least one game piece according to the game's rules, and at least one aperture allowing insertion of the game piece's protrusion that guides the at least one game piece through the plurality of permitted channels.

### FIELD OF THE INVENTION

The present invention is directed to a game for beginners, e.g., young tots, kids, and adults who are new at learning the game rules and proper movement of the various individual game pieces. This invention facilitates teachers and parents in teaching the proper rules and movement of game pieces, using channels specifically tailored for the type of game pieces, where each game piece's movement is confined to moving across the board according to the standard rules of the game, facilitating learning by repetition until the beginner understands the scope of the game piece's movement on their own.

### BACKGROUND OF THE INVENTION

While the general tenor of the invention concerns any board game having game pieces and movements dictated by the game's rules, to further highlight certain features of aspects of embodiments of the present invention, a discussion of one particular game, chess, shall be used as an example. It should be noted that mention of the game of chess, its rules, its game pieces, etc., are exemplary only and are not intended to limit the invention to chess alone.

The classic chess game is a board game played by two players on a chessboard with sixty-four (64) squares arranged in an eight-by-eight grid with alternating black and white squares comprising eight horizontal rows, and eight vertical columns. In classic chess, there are six different types of chess pieces, and each player is assigned a set of sixteen (16) movable game pieces: one (1) King, one (1) Queen, two (2) Rooks, two (2) Bishops, two (2) Knights and eight (8) Pawns, where the objective of the game is to “checkmate” the opposing player's King. To accomplish the winning objective, each player must strategically maneuver its chess game pieces to a different square on the chess board within the confines of the rules for movement of the specified/designated game piece, as the rules of the game places limitations on how and where each designated game piece is moved across the chess board.

For example, the King may generally move one square in any available direction (e.g., horizontally, vertically, or diagonally), while the Queen moves through any number of unobstructed squares in any straight line (e.g., horizontally, vertically, or diagonally), but is not allowed to jump other pieces. The Rook may move through any number of unobstructed squares in a straight line, either horizontally or vertically, but may not jump other game pieces. A Bishop similarly may not jump other game pieces but may move through any number of unobstructed squares in any straight diagonal line. The Knight may move in a first one-square step in either a horizontal or a vertical direction, and a second one-square step diagonally, and has the ability to jump other pieces. Generally, the Pawn may only move forward one square with the two exceptions: a) on its initial move, the Pawn may move forward one or two squares; or b) the Pawn captures other pieces by moving one square diagonally.

Although classic chess is well loved, learning all the rules for the different game pieces is often difficult, especially for young players. Several resources exist as to how to play a winning game of chess, e.g., books, online videos, etc., but a lot of these resources require at a minimum, a preliminary basic understanding of the rules of the game.

An exemplary resource is “No Stress Chess,” which provides chess pieces and a conventional chessboard. In order to move the pieces, the player is assisted by playing cards that provide the possible moves for each piece. This system does not work for children under 7 years old, who have difficulty understanding abstract concepts and are unable to read the cards in order to move the pieces correctly. The present invention is unlike “No Stress Chess” as the invention limits the player to moving the pieces in the correct manner only, according to the conventional rules of chess as the player learns by repetition.

Another exemplary resource is “Story Time Chess,” which teaches chess to young children using stories, colorful illustrations, custom chess pieces, and a chess board that has characters matching the chess pieces, enabling an easy setup of the chess game board. The stories and supporting materials communicate the rules of chess to children. The present invention is unlike “Story Time Chess” as it does not require the player to first understand a story in order to learn how the chess pieces move, and it only allows the player to move the chess pieces in the correct manner according to the conventional rules of chess, as they learn by repetition.

Therefore, there exists a need for a simplified method of teaching the game of chess with all the various rules for the movement of the different game pieces, regardless of whether the individual has a preliminary basic understanding of chess. Also, there is a need for teaching the specified game pieces' movements where the player can learn how to play within the confines of the various restricted movements under the rules of the game for each designated/specified chess piece while playing and having fun. This invention satisfies those needs and more.

It should be noted that the problem of teaching the rules of chess may also apply to other similar games as well. As stated above, this invention will use chess as an exemplary and non-limiting example and thus should not be thought to be limited to just chess.

### BRIEF SUMMARY OF THE INVENTION

Aspects of embodiments of the present invention contemplate an innovative new chess board with detachable assemblage(s) comprising of different smaller sized sub-boards, which when connected, form a classic chess board. Each sub-board of the game board apparatus has guided channels on a first side, within which a specific game piece can be moved in. These guided channels track the permitted movement for the particular game piece according to the rules of the game, e.g., chess. Each game piece is designed to fit through the channels of its specific designated sub-board. On the flip sides of each sub-board are squares such that when any four sub-boards are assembled together, they form a seamless 64 square classic chess board arranged in an eight-by-eight grid. The sub-boards include representative hardware providing for interlocking snap fit with the adjoining sub-board, such that when any 4 sub-boards are fully assembled, they are securely locked and form a complete class game board.

As previously discussed, the Pawn has limited mobility, e.g., under chess rules, the Pawn is not allowed to go backwards, so there is a need to prevent the Pawn when in play using the invention from moving backwards. An aspect of an embodiment of the present invention contemplates guide protrusions, comprising a flexible pawl that distorts enough to allow for example the game piece, e.g., the Pawn, to move forward but fouls with the ratchet teeth in the other direction to prevent the Pawn game piece from any backwards movement. Pawl, as used herein describes a pivoted curved bar or lever, whose free end engages with the teeth of a cogwheel or ratchet so that the wheel or ratchet can only turn or move in one direction. The pawl may be made from any flexible material including but not limited to plastic, rubber, poly vinyl chloride (PVC), and the like. Aspects of an embodiment of the present invention contemplate a ratchet mechanism, whereby each game piece may have special features that relate to its permitted movements as per the rules for the applicable game, e.g., classic chess. For instance, the channels for Pawns may include a ratchet mechanism that allows the Pawn to move forward but not backwards.

In another aspect of an embodiment of the present invention, the invention contemplates serrated channels where other game pieces with round protrusions to guide them, like the Rook, can move freely within the serrated channels.

Aspects of an embodiment of the present invention contemplate individual apertures on the game board apparatus that provides for the insertion of the game piece. In the preferred embodiment, the apertures are particularly/strategically placed and the game piece can only be inserted at that particular location on the game board. In other embodiments, the apertures may be strategically placed to allow for insertion of the game piece only at a limited plurality of locations.

In another aspect of an embodiment of the present invention, the invention contemplates specific game pieces that can move in any direction to include a protrusion, e.g., Bishop and other chess game pieces that are able to move in any direction. Each designated game piece may have its' own dedicated sub-board comprising at least one aperture and corresponding channels for the game piece to move in. Any 4 sub-boards may be assembled together to form the complete chess board.

An aspect of an embodiment of the present invention contemplates a game board apparatus for playing a game, which may include: a plurality of channels, at least one game piece, where each of the at least one game piece may include a protrusion, unique to each of the at least one game piece and extending from its base, where the protrusion guides the at least one game piece through the plurality of channels, and a plurality of game squares, where the plurality of squares are printed.

In an aspect of an embodiment of the present invention, the protrusion of the at least one game piece may include a flexible plastic pawl. In an aspect of an embodiment of the present invention, the plurality of channels may include ratchet teeth along walls of the plurality of channels for enabling movement of each of the at least one game piece in a particular direction as dictated by rules of the game. In one aspect, the flexible plastic pawl may operate to prevent movement of one particular game piece from moving in one direction.

In an aspect of an embodiment of the present invention, the game board apparatus may include at least two sub-boards, where the sub-boards are releasably interconnected using a plurality of connection tabs and a plurality of corresponding connection receptacles, and where the plurality of channels of each sub-board are alignable with each other.

Another aspect of an embodiment of the present invention contemplates a game board apparatus for playing a game, which may include: at least one game piece, where each of the at least one game piece may include a protrusion unique to each the at least one game piece and extending from its base, at least two sub-boards, where the at least two sub-boards are releasably interconnected using a plurality of connection tabs and a plurality of corresponding connection receptacles, and where the plurality of channels of each sub-board are alignable with each other, a transparent cover for each the at least two sub-boards, where each transparent cover may include at least one channel, where the at least one channel may be modelled after movement allowed by rules of the game for the at least one game piece, a base for each of the at least two sub-boards, and at least one aperture allowing insertion of the protrusion of the at least one game piece, where the at least one aperture may be connected to the at least one channel.

In another aspect of an embodiment of the present invention, each of the at least two sub-boards may be unique to each of the at least one game piece. In another aspect of an embodiment of the present invention, the protrusion of the at least one game piece guides the at least one game piece through the at least one channel.

In another aspect of an embodiment of the present invention, the game board may further include: a printed game card between the at least one transparent cover of the at least two sub-boards and the base of the at least two sub-boards, and a plurality of connection tabs and a plurality of corresponding connection receptacles which enable the at least two sub-boards to be releasably interconnected.

In another aspect of an embodiment of the present invention, the game board apparatus may include sub-boards which are unique to each at least one game piece.

Another aspect of an embodiment of the present invention contemplates a game board apparatus for playing a game, which may include: any one of: at least two sub-boards, a single board, at least one game piece, where each of the at least one game piece may include a magnet within its base, a surface for any one of: at least two sub-boards, a single board, a base for any one of: the at least two sub-boards, the single board, and a plurality of magnets positioned between the surface and base for any one of: the at least two sub-boards, the single board, where the any one of: at least two sub-boards, a single board may be divided into playing squares where some of the plurality of magnets are positioned under some of the squares.

In another aspect of an embodiment of the present invention, the poles of some of the plurality of magnets positioned between the surface and base for the at least two sub-boards may be aligned with poles of magnets within the at least one game piece. As a result, when the game piece is moved to a position on the board that is not allowed by the rules of the game, the game piece would be repelled by the aligned magnetic forces, thus enabling the student to learn that the movement was not allowed under the rules of the game.

A further aspect of an embodiment of the present invention contemplates a game board apparatus for playing a game, which may include: any one of: at least two sub-boards, a single board, at least one game piece, where each of the at least one game piece may include a protrusion extending from its base, a plurality of mounting fenestrations, at least one removable movement channel apparatus, where each of the at least one removable movement channel apparatus may include mounting pegs corresponding to the plurality of mounting fenestrations, and a printed board card.

In a further aspect of an embodiment of the present invention, the at least one removable movement channel apparatus may include at least one channel for enabling movement of the at least one game piece, where the at least one channel may be modelled after movement allowed by rules of the game for the at least one game piece.

In a further aspect of an embodiment of the present invention, the game board apparatus may include at least one or more apertures for enabling insertion of the protrusion of at least one game piece onto the at least one channel.

A still further aspect of an embodiment of the present invention contemplates a game board apparatus for playing a game, which may include: any one of: at least two sub-boards, a single board, at least one game piece, where each of the at least one game piece may include a protrusion extending from its base, a plurality of channels or grooves on the any one of: at least two sub-boards, a single board, where the at least one game piece traverses through the plurality of channels by way of the protrusions, and at least one movement stop located within the plurality of channels.

In a still further aspect of an embodiment of the present invention, the plurality of channels may include ratchet type walls.

In a still further aspect of an embodiment of the present invention, the at least one game piece further may include any one of: a bottom guide apparatus, spigot, where the any one of: a bottom guide apparatus, spigot may be attached to the protrusion.

In a still further aspect of an embodiment of the present invention, the bottom guide apparatus may include a pawl guide which limits movement in one direction.

### BRIEF DESCRIPTION OF THE DRAWINGS

FIG. 1A illustrates a game board apparatus having multiple sub-boards, according to aspects of embodiments of the present invention.

FIG. 1B illustrates a detailed view of a game board apparatus' sub-boards, according to aspects of embodiments of the present invention.

FIG. 1C illustrates a detail of a connection apparatus of a game board apparatus, according to an aspect of embodiments of the present invention.

FIG. 1D illustrates another detail of a connection apparatus, according to an aspect of embodiments of the present invention.

FIG. 1E illustrates a game board apparatus fully assembled, according to an aspect of an embodiment of the present invention.

FIG. 1F illustrates a sub-board specific to a game piece, according to an aspect of embodiments of the present invention.

FIG. 1G illustrates a sub-board showing game pieces, according to an aspect of embodiments of the present invention.

FIG. 1H illustrates a game piece and a portion of a sub-board, according to an aspect of embodiments of the present invention.

FIG. 1I illustrates a ratchet mechanism of a sub-board, according to an aspect of embodiments of the present invention.

FIG. 1J illustrates a cross-sectional view of a game piece through a channel and a section of a sub-board, according to an aspect of embodiments of the present invention.

FIG. 2A illustrates a game board apparatus comprising of a plurality of sub-boards designed for individual game pieces, according to an aspect of embodiments of the present invention.

FIG. 2B illustrates a game board apparatus comprising of multiple sub-boards, each with a transparent cover, according to an aspect of embodiments of the present invention.

FIG. 2C illustrates a sub-board and a game piece according to an aspect of embodiments of the present invention.

FIG. 3A illustrates a game board apparatus with an exemplary game piece on the apparatus' sub-board, according to an aspect of embodiments of the present invention.

FIG. 3B illustrates a cross-sectional view of a game board apparatus that includes multiple magnets, and a game piece, according to an aspect of embodiments of the present invention.

FIG. 4A illustrates a game board apparatus having multiple sub-boards comprising of a plurality of removable movement channel apparatuses, according to an aspect of embodiments of the present invention.

FIG. 4B illustrates a sub-board of a game board apparatus showing a removable movement channel apparatus and a game piece, according to an aspect of embodiments of the present invention.

FIG. 4C illustrates a cross-sectional view of a game piece and a sub-board of a game board apparatus showing a specific channel, according to an aspect of embodiments of the present invention.

FIG. 4D illustrates a cross-sectional view of a game piece and a sub-board of a game board apparatus having a removable channel, according to aspects of embodiments of the present invention.

FIG. 5A illustrates game board apparatus with a plurality of game pieces, with the game board apparatus having a plurality of grooves, according to aspects of embodiments of the present invention.

FIG. 5B illustrates a cross-sectional view of a game piece and a sub-board of a game board apparatus, according to aspects of embodiments of the present invention.

FIG. 5C illustrates another cross-sectional view of a game piece and a sub-board of a game board apparatus, according to aspects of embodiments of the present invention.

FIG. 5D illustrates a sub-board along with specific game pieces and game piece movement grooves on the sub-board, according to aspects of embodiments of the present invention.

FIG. 5E illustrates a cross-sectional view of a groove of a sub-board of a game board apparatus, according to aspects of embodiments of the present invention.

### DETAILED DESCRIPTION OF THE INVENTION

The following discussion describes in detail, varied embodiments of the apparatus disclosed herein. However, this discussion should not be construed, as limiting the invention to those particular embodiments as practitioners skilled in the art will appreciate that the apparatus may vary as to configuration and as to details of the parts, without departing from the basic concepts as disclosed herein. Similarly, the elements described herein may be implemented separately, or in various combinations without departing from the teachings of the present invention.

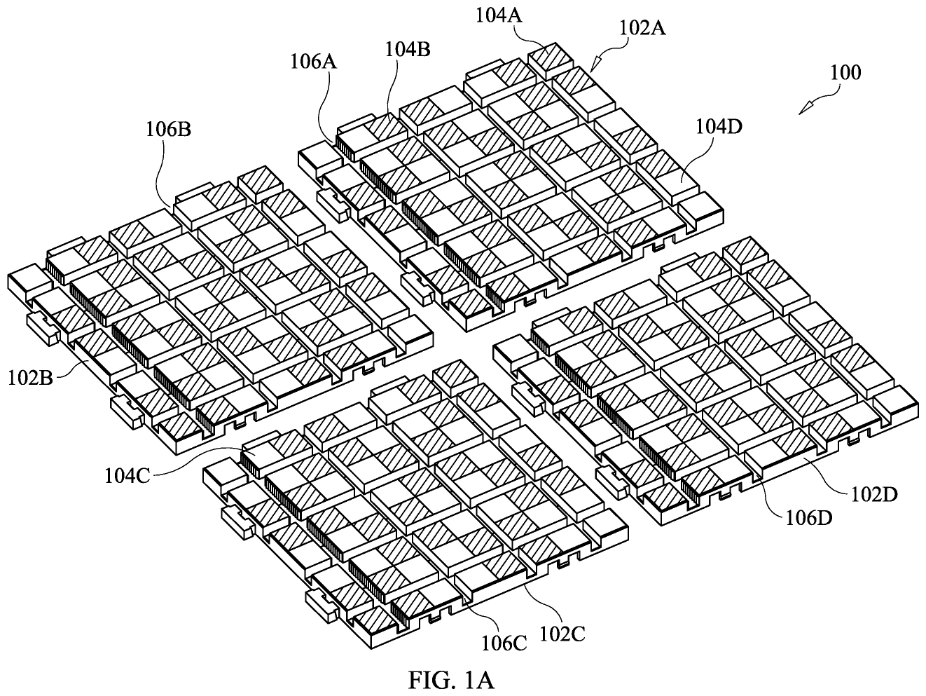

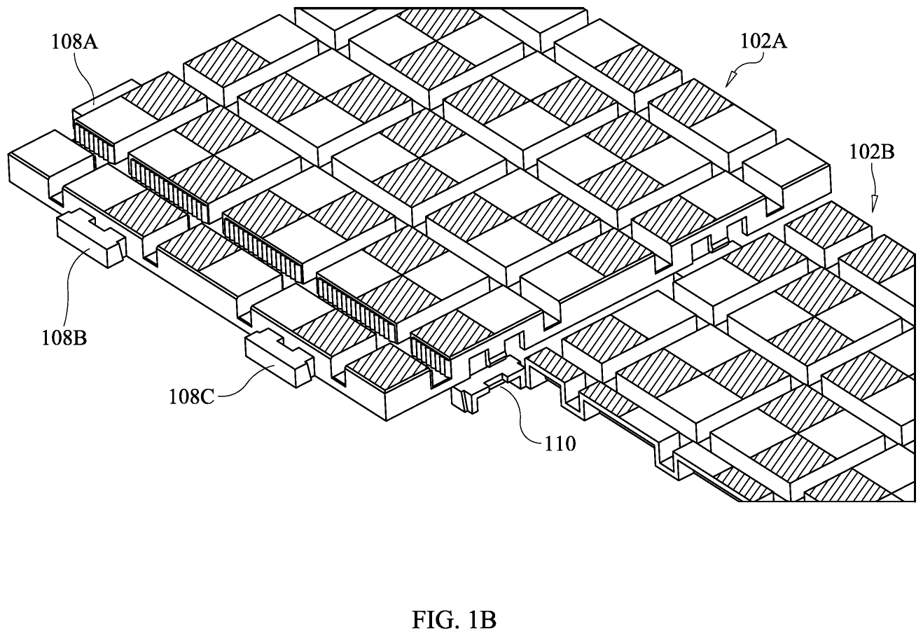

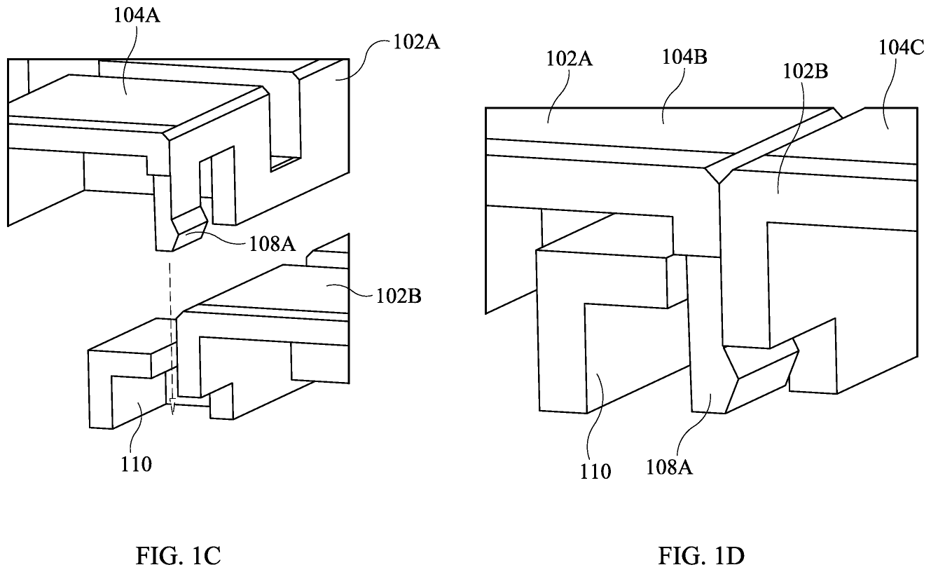

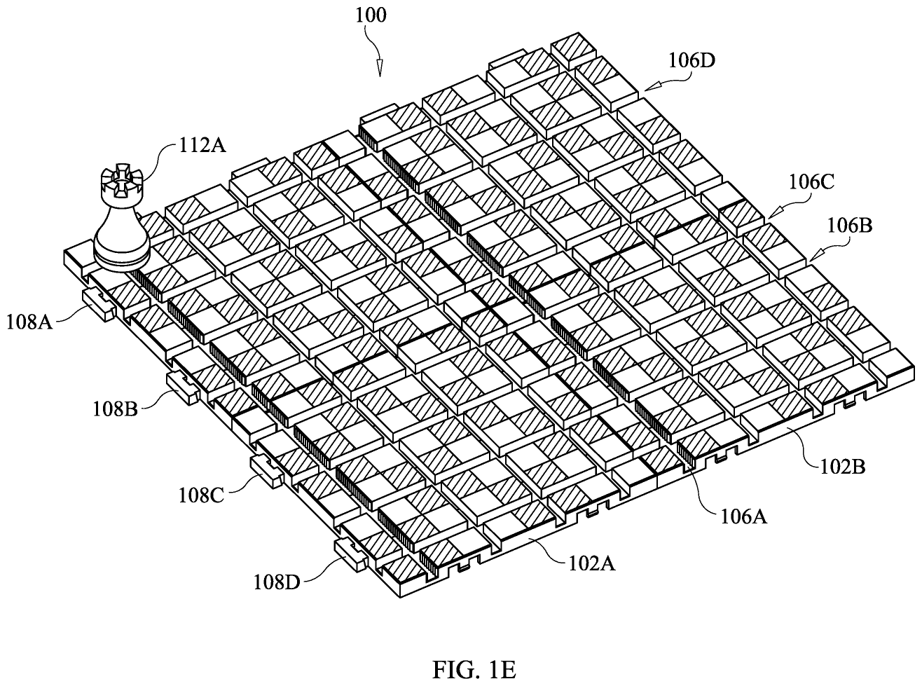

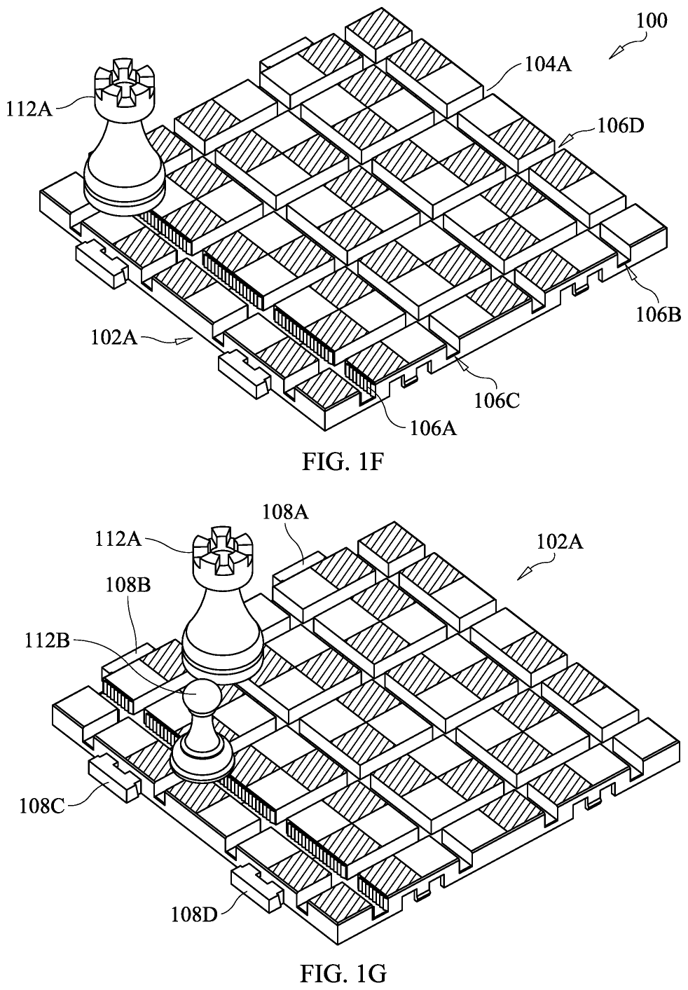

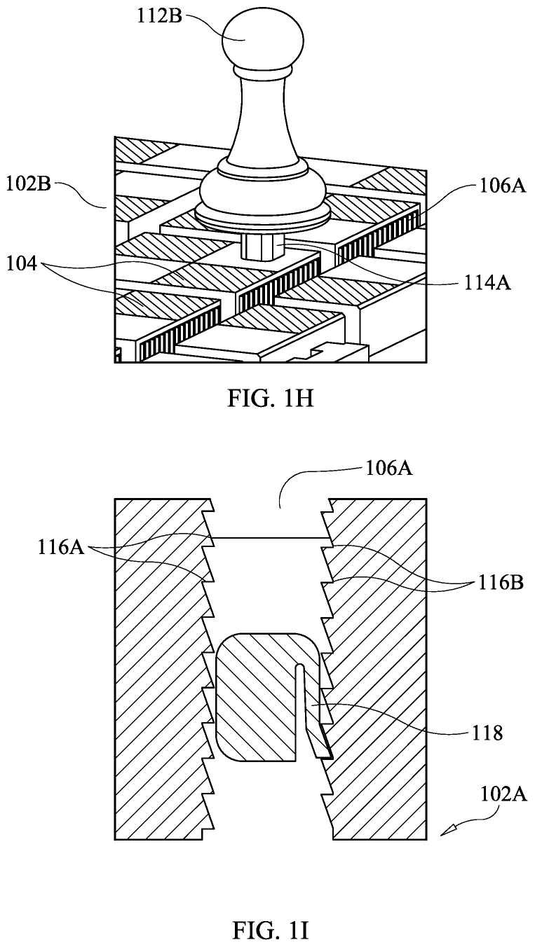

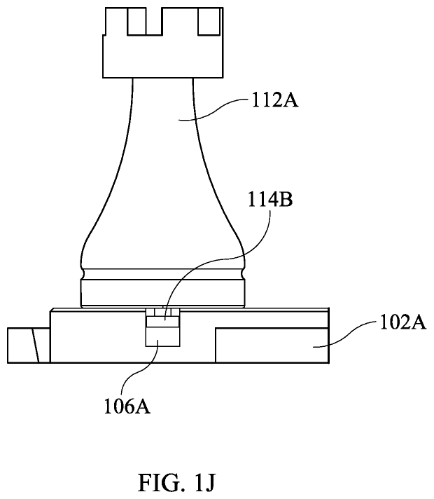

Referring now to FIGS. 1A through 1J, a game board apparatus 100 is shown along with multiple sub-boards 102A through 102D and game pieces 112A, 112B, according to aspects of embodiments of the present invention. Game board apparatus 100 may comprise of sub-boards 102A through 102D for which each sub-board 102A through 102D may sized smaller than a regular game board and may be connected with another to form one game board 100 of regular size. Squares 104A through 104D according to an aspect of the present embodiment of the invention could be a section of the game position on the board 100 or the entire game position. Game board apparatus 100 may also include a plurality of channels 106A through 106D which, in the instance of sub-boards 102A through 102D, may be aligned together to form a continuous channel 106 across sub-boards 102A through 102D.

FIG. 1B illustrates a detailed view of a game board apparatus' sub-boards 102A through 102D, according to aspects of embodiments of the present invention. In an aspect of an embodiment of the present invention, each of the sub-boards 102A through 102D may be interconnected with each other by way of a plurality of connection tabs 108A through 108D on one sub-board 102A and corresponding connection tab receptacles 110 on the other sub-board 102B (see FIGS. 1B through 1E). In an aspect of the invention, each of the sub-boards 102A through 102D may have connection tabs 108A through 108D on two sides of the sub-board 102A through 102D and receptacles 110 on two sides of the sub-board 102A through 102D to enable assembly in any order.

FIGS. 1C & 1D illustrate details of a connection apparatus of a game board apparatus 100, according to aspects of embodiments of the present invention. As shown in FIG. 1C where the sub-boards 102A, 102B are disengaged, each sub-board 102A may be engaged with another sub-board 102B forming an interlocking snap fit as shown in FIG. 1D. When connection tabs 108A through 108D and receptacles 110 are fully engaged, each connection between tabs 108A through 108D and receptacles 110 is strong enough to hold sub-boards 102A through 102D together. They may also be flexible enough so that they can be disassembled by lifting the sub-boards that have tabs. Tabs 108A through 108D may have enough flexibility to allow for ease of disassembly.

FIG. 1E illustrates a game board apparatus 100 fully assembled, according to an aspect of an embodiment of the present invention. Game board apparatus 100 may include one, two or more sub-boards 102A through 102D assembled together, and also include game pieces 112A, 112B, which may include game piece protrusions 114A, 114B as shown in FIG. 1H, which may be used to traverse game pieces 112A, 112B through channels 106A through 106D.

FIG. 1F illustrates a sub-board 102A specific to a game piece 112A, according to an aspect of embodiments of the present invention, wherein the game piece 112A has specific channels 106A through 106D through which it will be guided. Here as shown, the game piece 112A may be inserted into, or removed from its specific guide channels 106A through 106C on its dedicated sub-board 102A, at any location. In some aspects of the invention, the same sub-board 102A may be used for one or more game pieces 112A, 112B as shown in FIG. 1G. In an aspect of an embodiment of the present invention, the invention contemplates serrated channels 106A where game pieces 112A through 112D with round protrusions 114A, 114B to guide them, like the Rook, can move freely within the serrated channels 106A.

FIG. 1H illustrates a game piece 112B and a portion of a sub-board 102B, according to an aspect of embodiments of the present invention. A game piece's protrusion 114A may differ from another game piece's protrusion 114B, as the protrusion's shape and characteristics depend on the game piece's 112B permitted movements according to the game's rules as tracked on the apparatus' sub-board 102B. For instance as shown, the game piece protrusion 114A may be rectangular for the exemplary game piece 112B, e.g., the Pawn, so that the Pawn 112B may not be turned, and may only go forward, but not backwards. Additionally, the protrusion 114A may be longer than a channel 106A so that it cannot move sideways across into the cross channels 106B-106D.

FIG. 1I illustrates a ratchet mechanism of a sub-board 102A, according to an aspect of embodiments of the present invention. For instance, the walls of channels 106A may include ratchet walls 116A, 116B which, in one aspect of an embodiment of the present invention, can be used to limit the movement of one or more game pieces 112A, 112B. As an example, where game piece 112B is a Pawn (in chess), game piece 112B may have a guide protrusion 118, which may be a pawl that distorts enough to move forward but fouls with the ratchet walls 116A and 116B in the other direction to prevent backwards movement of game piece 112B (see FIGS. 1H and 1I).

FIG. 1J illustrates a cross-sectional view of a game piece 112A through a channel 106A and a section of a sub-board 102B, according to an aspect of embodiments of the present invention. In an aspect of an embodiment of the invention, each game piece 112A may have special features that relate to the movement of the game piece 112A according to the game's rules. For instance, other protrusions may enable the game piece 112A to move freely within channels 106A through 106D, such as protrusion 114A for game piece 112A which has a rounded protrusion 114B. Where, in chess, game piece 112A is a Rook, the Rook 112A may be able to traverse channels 106A according to the rules of chess.

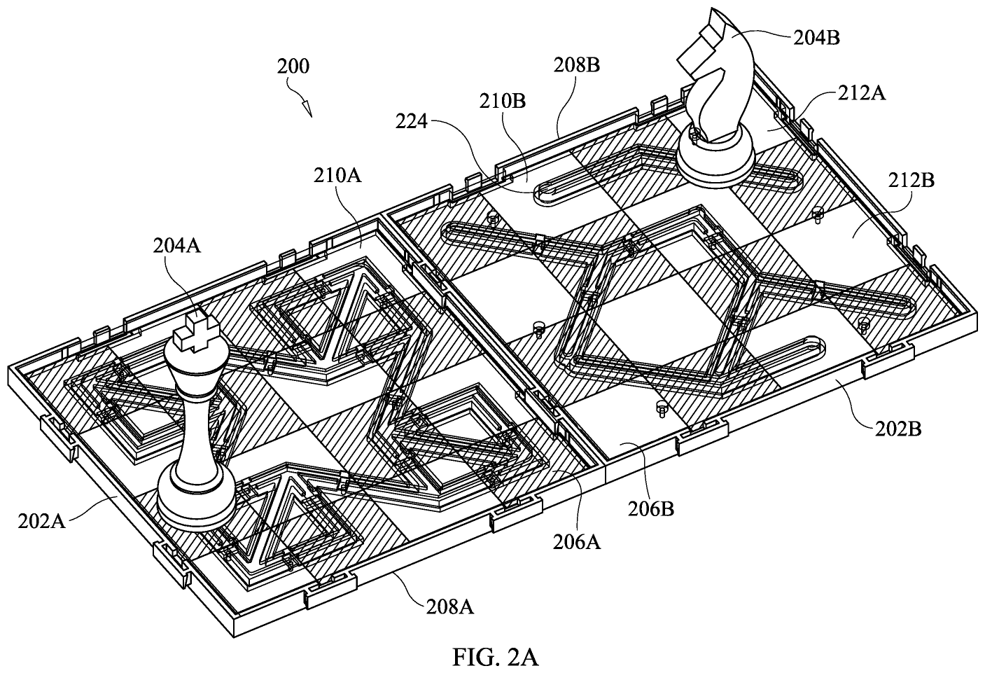

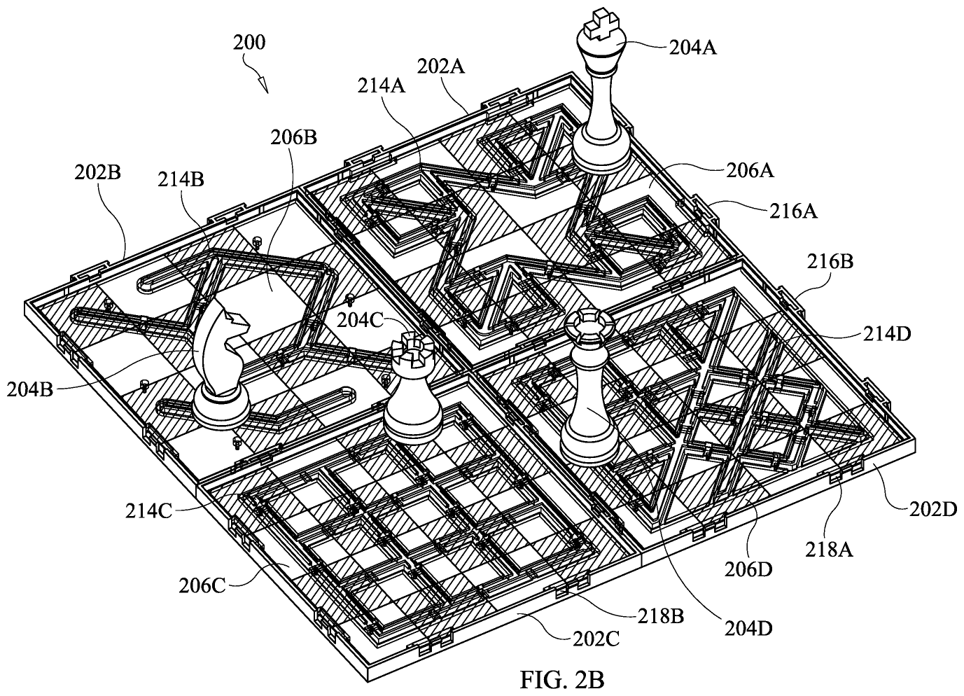

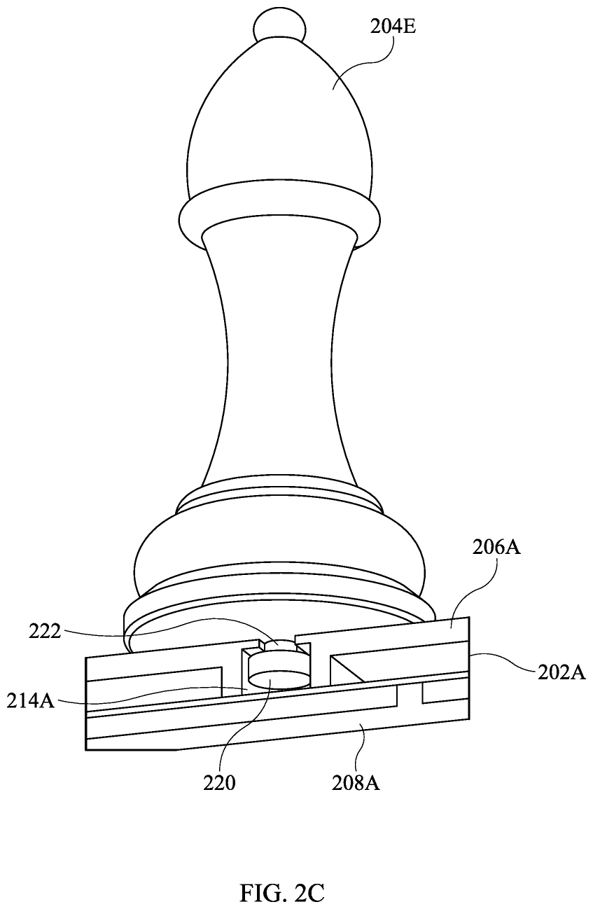

FIG. 2A illustrates a game board apparatus 200 comprising of a plurality of sub-boards 202A, 202B designed for specific individual game pieces 204A, 204B, according to an aspect of embodiments of the present invention. Game board apparatus 200 may include game pieces 204A through 204E, sub-boards 202A through 202D that may each include: a transparent cover 206A; a sub-board body 208A; and a printed card 210A, each sandwiched between each of the transparent covers 206A through 206D, and each of sub-board bodies 208A, 208B. Printed cards 210A, 210B have the representative game squares 212A, 212B marked for the particular game, e.g. in an exemplary game of chess, the printed cards 210A through 210D would include the marked exemplary games squares 212A, 212B printed thereon. Transparent covers 206A through 206D enable a player or learner to see the game squares 212A, 212B on the printed card 210A through 210D.

FIG. 2B illustrates a game board apparatus 100 comprising of multiple sub-boards 202A through 202D, each with a transparent cover 206A through 206D, according to an aspect of embodiments of the present invention. Here, each sub-board 202A through 202D is specifically designed for each game pieces 204A through 204E, so each sub-board 202A through 202D may have channels 214A through 214D specific to the permitted movements for each corresponding game piece 204A according to the rules of the game. It should be noted that different layouts of channels 214A through 214D are also contemplated according to aspects of embodiments of the present invention. For example, as shown in FIG. 2B, channels 214A through 214D for a game piece 204A, like an exemplary King 204A in a chess game, differs from the channels 214A through 214D for a different game piece 204B, e.g., the Knight 204B. Each of the sub-boards 202A through 202D may include connection receptacles 216A, 216B and corresponding tabs 218A, 218B for connecting each of sub-boards 202A through 202D.

FIG. 2C illustrates a sub-board 202A and a game piece 204E, according to an aspect of embodiments of the present invention. In an aspect of an embodiment of the present invention, each of game pieces 204A through 204E may include a corresponding game piece protrusion 220, which may be used to enable each game piece to traverse through its corresponding channels 214A through 214D. In an aspect of an embodiment of the present invention, the protrusion 220 includes a neck 222, which prevents each of game pieces 204A through 204D from being removed from corresponding channels 214A through 214D. Sub-boards 202A through 202D may include apertures 224, which enable insertion of each game piece 204A into its corresponding sub-board 202A. In the preferred embodiment, the apertures 224 are particularly/strategically placed and the specific game piece 204A can only be inserted at that particular location on the game board 200. In other embodiments, the apertures 224 may be strategically placed to allow for insertion of the game piece 204A only at a limited plurality of locations on the sub-board 202A.

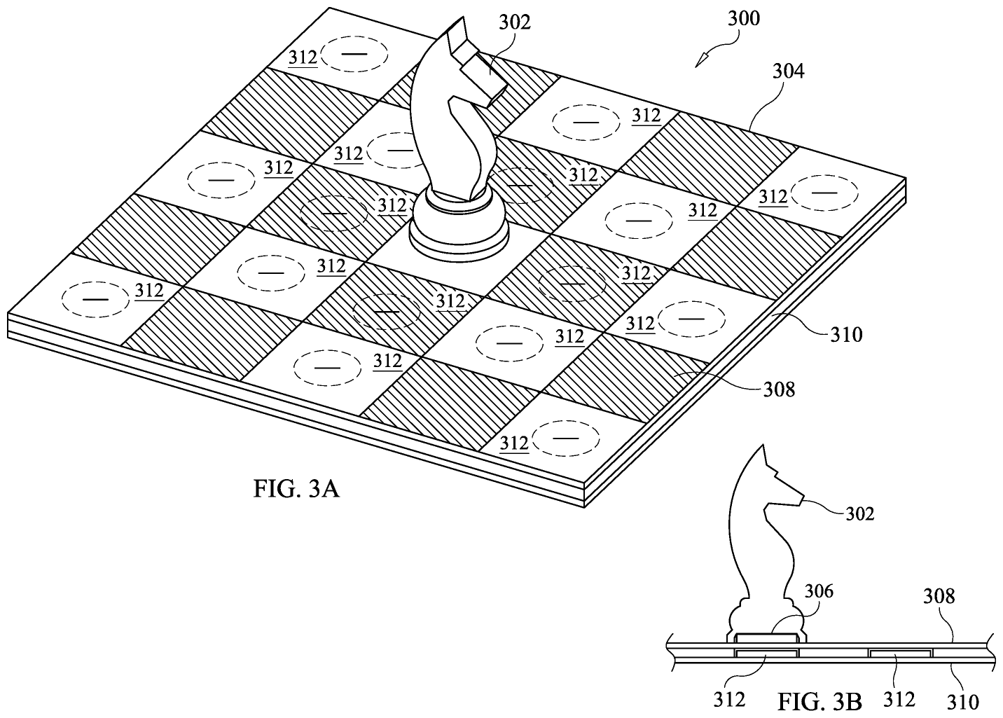

FIG. 3A illustrates a game board apparatus 300 with an exemplary game piece 302 on the apparatus' sub-board 304, according to an aspect of embodiments of the present invention. In an aspect of an embodiment of the present invention, each game piece 302 has at least one or more corresponding magnets 306. The sub-board 304 may be specific a particular game piece 302 and includes a plurality of magnets 312 laid out between respective sub-board surface 308 and sub-board base 310 in an arrangement that allows for permitted movements of each game piece 302 according to the permitted game rules.

In an aspect of an embodiment of the present invention, the paths for the game pieces' correct movement may be printed on the sub-board surface 308 and magnets 312 may be positioned where the game piece 302 is not allowed to go. In an aspect of an embodiment of the present invention, for the game square(s) where the game piece 302 is not allowed to go, the polarity of magnets 312 may be set to align with the same polarity of game piece magnet 306 so as to repel the game piece 302 when placed over the non-permitted game square(s).

FIG. 3B illustrates a cross-sectional view of a game board apparatus 300 that includes multiple magnets 312, and a game piece 302, according to an aspect of embodiments of the present invention. In an aspect of an embodiment of the present invention, where for instance the permitted movements are more complex, e.g., the Knight 302 as shown, the magnets 312 are helpful in preventing the player from placing the game piece 302 in game squares where the game piece 302 is not allowed to go.

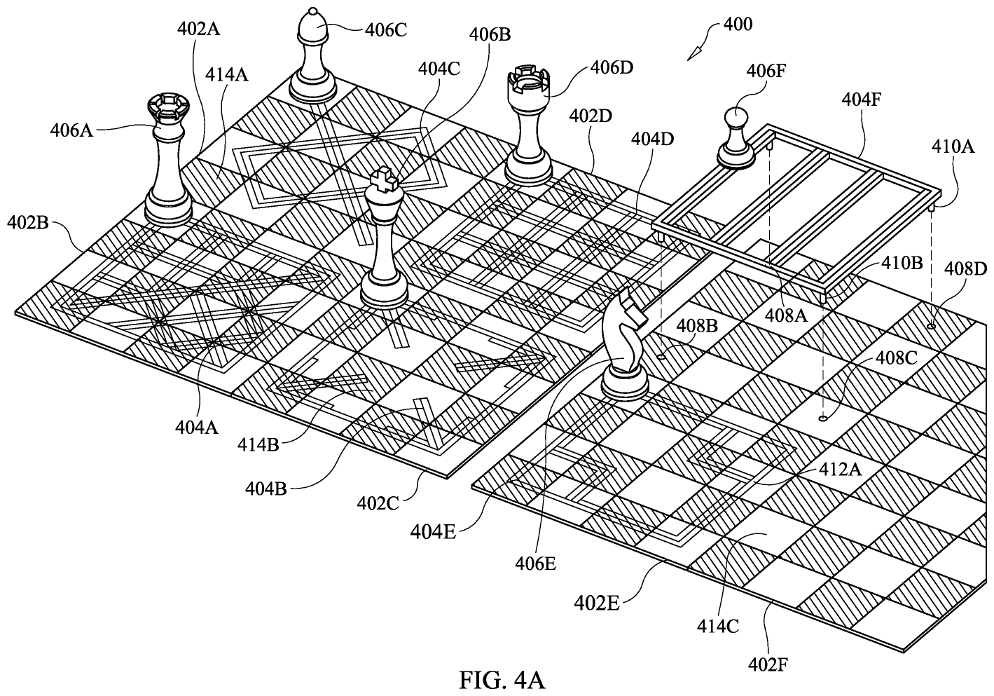

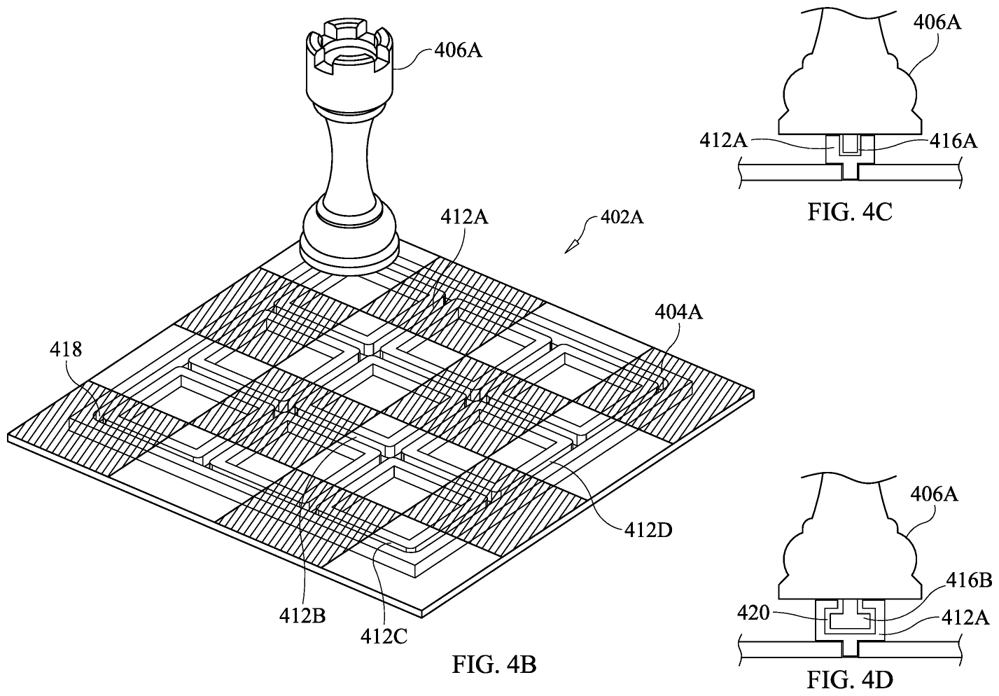

FIG. 4A illustrates a game board apparatus 400 having multiple sub-boards 402A through 402F comprising of a plurality of removable movement channel apparatuses 404A through 404F, according to an aspect of embodiments of the present invention. The game board apparatus 400 is shown with game pieces 406A through 406F, where the game board apparatus 400 may include a plurality of mounting fenestrations 408A through 408D within which the plurality of removable movement channel apparatuses 404A through 404F may be mounted onto game board apparatus 400 by way of corresponding mounting pegs 410A, 410B of plurality of removable movement channel apparatuses 404A through 404F. The plurality of removable movement channel apparatuses 404A through 404F may each have channels 412A through 412D, which correspond to the permitted movements for each of the game pieces 406A through 406F according to the rules of the game.

Game board apparatus 400 may, in an aspect of an embodiment of the present invention, comprise of removably interconnected sub-boards 402A through 402F, each of which may be specific for each game piece 406A through 406F. Game board apparatus 400 may also include a game board printed cards 414A, 414B, which may display the outlines of the board 400 with the corresponding game squares. The plurality of removable movement channel apparatuses 404A through 404F may be transparent to enable a player to see the printed card 414 with the game squares underneath the plurality of removable movement channel apparatuses 404A through 404F, when mounted.

FIG. 4B illustrates a sub-board 402A of a game board apparatus 400 showing a removable movement channel apparatus 404A and a corresponding game piece 406A, according to an aspect of embodiments of the present invention. In an aspect of embodiments of the invention, each of the game pieces 406A through 406F may have protrusions 416A, 416B, which may be used to traverse channels 412A through 412D of the plurality of removable movement channel apparatuses 404A through 404F. Channels 412A through 412D may, in an aspect of an embodiment of the present invention, have apertures 418 which enable insertion of each game piece 406A through 406F into channels 412A through 412D, and may have a recess 420 to prevent the game piece 406A from accidentally sliding off the game board 400.

FIGS. 4C & 4D illustrate cross-sectional views of a game piece 406A and a sub-board 402A of a game board apparatus 400 showing a specific channel 412A, according to an aspect of embodiments of the present invention. As shown, the game piece protrusion 416A may have different shapes, to move along the dedicated channel 412A retaining the game piece 406A on the board 400, where the channel 412A includes a recess 420 that may be open for a spigot 416A in the game piece 406A to slide along the channel 412A.

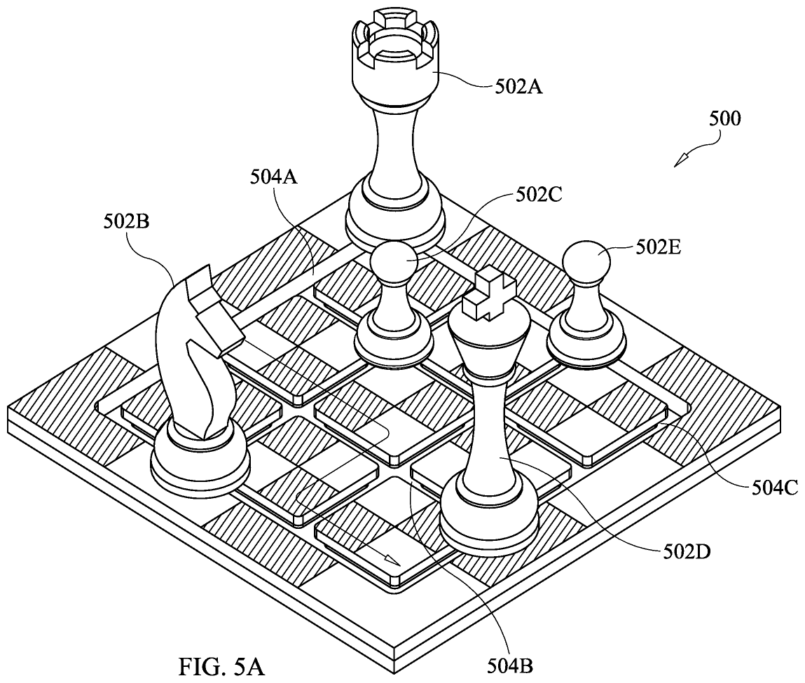

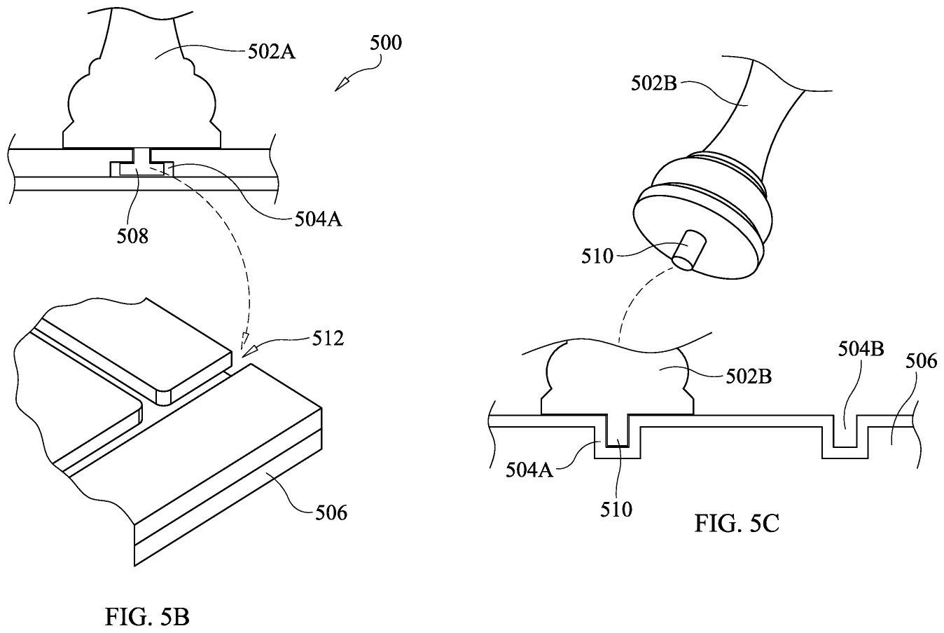

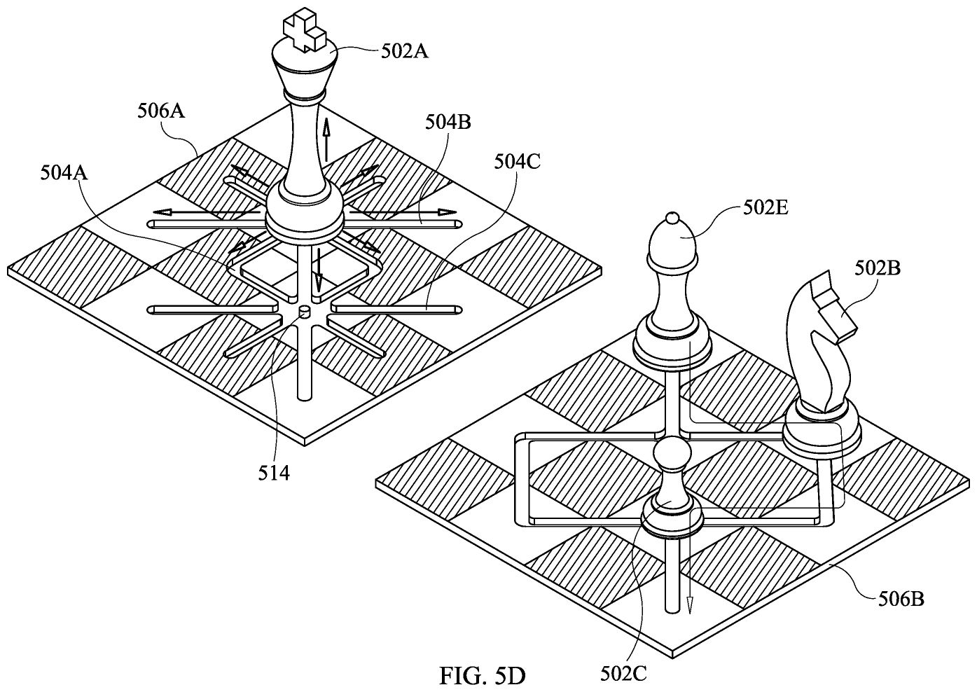

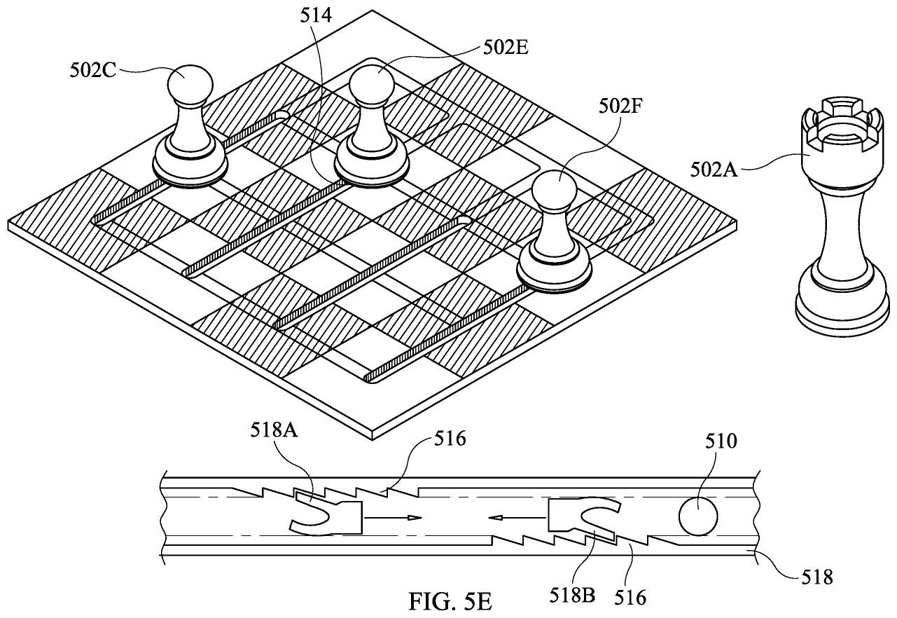

FIG. 5A illustrates game board apparatus 500 with a plurality of game pieces 502A through 502E, with the game board apparatus 500 having a plurality of grooves 504A through 504C, according to aspects of embodiments of the present invention. Here game board apparatus 500, may, in an aspect of an embodiment, may be at least two sub-boards 506A, 506B, or a single board. Game board apparatus 500 may also include a plurality of channels or grooves 504A through 504C on said any one of: at least two sub-boards 506A, 506B, a single board.

FIG. 5B illustrates a cross-sectional view of a game piece 502A and a sub-board 506 of a game board apparatus 500, according to aspects of embodiments of the present invention. In an aspect of an embodiment of the present invention, each of the game pieces 502A through 502E may include a game piece protrusion 518 extending from each base of pieces 502A through 502E, each of which may be any one of: a bottom guide apparatus 508, or a spigot 510, wherein said any one of: a bottom guide apparatus 508, or spigot 510 is attached to said protrusion. Each of the game pieces 502A through 502E are able to traverse through said plurality of grooves 504A through 504C by way of said game piece's bottom guide apparatus 508 or spigot 510. In an aspect of an embodiment of the present invention, the board 500 or the sub-boards 506A, 506B would have at least one open groove 504A that is opened up to the game board's edge 512 to allow insertion of the game piece 502A or pieces 502A-502E unto the sub-boards 506A, 506B. The bottom guide apparatus 508 may include a disc at the base of the game piece 502A, such that the game piece 502A remains in the groove 504A.

FIG. 5C illustrates another cross-sectional view of a game piece 502B and a sub-board 506 of a game board apparatus 500, according to aspects of embodiments of the present invention. In an aspect of an embodiment of the present invention, the game piece 502A, comprises of a spigot 510 that is attached to said protrusion, wherein the spigot 510 allows the game piece 502A to remain in the groove 504A.

FIG. 5D illustrates a sub-board 506A, 506B along with specific game pieces 502A, 502B, 502E and game piece movement grooves 504A, 504B, 504C on the sub-boards 506A, 506B. In an aspect of an embodiment of the present invention, each of the plurality of grooves/channels 504A through 504C may include at least one movement stop 514, to prevent the game piece 502A from being moved in a manner that is not permitted according to the game rules. For instance, in an exemplary classic chess game, the King generally is restricted to moving only one square horizontally, vertically, or diagonally, unless the King is castling, i.e., a double move where the King moves two squares towards a Rook, then moving the Rook onto the square over which the King crossed. As such, in an aspect of embodiments of the invention, the movement stop 514 prevents game pieces 502A through 502E, like the King, from a double move as necessarily the player must lift the King or go around the movement stop 514, which blocks such impermissible game play.

FIG. 5E illustrates a cross-sectional view of a groove 504A of a sub-board 506 of a game board apparatus 500, according to aspects of embodiments of the present invention. To limit the movement of certain game pieces 502A through 502E, the channels 504A through 504F may include ratchet walls 516 or mechanism 516 which may limit a game piece's movement in a certain direction. In an aspect of an embodiment of the invention, game pieces 502A through 502E include game piece guide protrusions 518A, 518B, e.g., a pawl that distorts enough to move forward but fouls with the ratchet mechanism 516 in the other direction to prevent backwards movement, to guide the game pieces 502A through 502E through the channel's ratchet walls 516. An exemplary game piece 502C, e.g., the Pawn 502C, includes the pawl that distorts enough to move forward but fouls with the ratchet mechanism 516 in the other direction to prevent backwards movement, while an exemplary Rook 502D may include a spigot 510 that does not engage the teeth of the ratchet mechanism 516 so it moves freely in the grooves 504A through 504C.

Although aspects of embodiments of the present invention have been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features all without departing from the present invention as outlined above, in the appended drawings and the claims presented below.

In all aspects of embodiments of the present invention as disclosed herein, it should be noted that the number of sub-boards and game pieces here is merely exemplary only and not limiting as more sub-boards and/or game pieces are contemplated according to aspects of embodiments of the present invention.

While certain elements of this invention have been shown, described and/or claimed, it is not intended to be limited to the details above, since it will be understood that various omissions, modifications, substitutions and changes in the apparatuses, forms, method, steps and system illustrated and, in its operation, can be made by those skilled in the art without departing in any way from the spirit of the present invention.

What is claimed is:

1. A game board apparatus for playing a game, comprising:
a plurality of channels;
at least one game piece, wherein each of said at least one game piece comprises of a protrusion unique to each said at least one game piece and extending from its base, wherein said protrusion guides said at least one game piece through said plurality of channels; and
a plurality of game squares, wherein said plurality of squares are printed.

2. The game board apparatus of claim 1, wherein said protrusion of said at least one game piece comprises of flexible plastic pawl.

3. The game board apparatus of claim 1, wherein said plurality of channels comprises of ratchet teeth along walls of said plurality of channels for enabling movement of each of said at least one game piece in a particular direction as dictated by rules of said game.

4. The game board apparatus of claim 1, wherein said board apparatus comprises of at least two sub-boards, wherein said sub-boards are releasably interconnected using a plurality of connection tabs and a plurality of corresponding connection receptacles, and wherein the plurality of channels of each sub-board are alignable with each other.

5. A game board apparatus for playing a game, comprising:
at least one game piece, wherein each of said at least one game piece comprises of a protrusion unique to each said at least one game piece and extending from its base;
at least two sub-boards, wherein said at least two sub-boards are releasably interconnected using a plurality of connection tabs and a plurality of corresponding connection receptacles, and wherein the plurality of channels of each sub-board are alignable with each other;
a transparent cover for each said at least two sub-boards, wherein each transparent cover comprises of at least one channel, wherein said at least one channel is modelled after movement allowed by rules of said game for said at least one game piece;
a base for each of said at least two sub-boards; and
at least one aperture allowing insertion of said protrusion of said at least one game piece, wherein said at least one aperture is connected to said at least one channel.

6. The game board of claim 5, wherein each of said at least two sub-boards is unique to each of said at least one game piece.

7. The game board of claim 5, wherein said protrusion of said at least one game piece guides said at least one game piece through said at least one channel.

8. The game board of claim 5, further comprising:
a printed game card between said at least one transparent cover of said at least two sub-boards and said base of said at least two sub-boards;
a plurality of connection tabs and a plurality of corresponding connection receptacles which enable said at least two sub-boards to be releasably interconnected.

9. A game board apparatus for playing a game, comprising:
any one of: at least two sub-boards, a single board;
at least one game piece, wherein each of said at least one game piece comprises of a magnet within its base;
a surface for any one of: at least two sub-boards, a single board;
a base for any one of: at least two sub-boards, a single board; and
a plurality of magnets positioned between said surface and base for any one of: at least two sub-boards, a single board; wherein said any one of: at least two sub-boards, a single board is divided into playing squares wherein some of said plurality of magnets are positioned under some of said squares.

10. The game board apparatus of claim 9, comprising of sub-boards unique to each at least one game piece.

11. The game board apparatus of claim 10, wherein some of said plurality of magnets positioned between said surface and base for said at least two sub-boards have their poles aligned with poles of magnets within said at least one game piece.

12. A game board apparatus for playing a game, comprising:
any one of: at least two sub-boards, a single board;
at least one game piece, wherein each of said at least one game piece comprises of a protrusion extending from its base;
a plurality of mounting fenestrations;
at least one removable movement channel apparatus, wherein each of said at least one removable movement channel apparatus comprises of mounting pegs corresponding to said plurality of mounting fenestrations; and
a board card.

13. The game board apparatus of claim 12, wherein said at least one removable movement channel apparatus comprises of at least one channel for enabling movement of said at least one game piece, wherein said at least one channel is modelled after movement allowed by rules of said game for said at least one game piece.

14. The game board apparatus of claim 13, comprising at least one apertures for enabling insertion of said protrusion of at least one game piece onto said at least one channel.

15. A game board apparatus for playing a game, comprising:
any one of: at least two sub-boards, a single board;
at least one game piece, wherein each of said at least one game piece comprises of a protrusion extending from its base;
a plurality of channels or grooves on said any one of: at least two sub-boards, a single board, wherein said at least one game piece traverses through said plurality of channels by way of said protrusions; and
at least one movement stop located within said plurality of channels.

16. The game board apparatus of claim 15, wherein said plurality of channels comprises of ratchet type walls.

17. The game board apparatus of claim 16, wherein said at least one game piece further comprises any one of: a bottom guide apparatus, spigot, wherein said any one of: a bottom guide apparatus, spigot is attached to said protrusion.

18. The game board apparatus of claim 17, wherein said bottom guide apparatus comprises of a pawn guide which limits movement in one direction.
